(19) United States
(12) Patent Application Publication
(10) Pub. No.: US 2008/0135793 A1
(43) Pub. Date: Jun. 12, 2008

(54) CLOSURE FOR CAN FILLER PORT AND CAN VENT

(75) Inventors: Charlie L. Forbis, Quapaw, OK (US); Larry L. Chrisco, Fairland, OK (US)

Correspondence Address: HOVEY WILLIAMS LLP, 10801 Mastin Blvd., Suite 1000, Overland Park, KS, 66210, US

(73) Assignee: BLITZ U.S.A., INC., Miami, OK (US)

(21) Appl. No.: 11/609,248

(22) Filed: Dec. 11, 2006

(51) Int. Cl. F16K 5/00

(52) U.S. Cl. 251/309

(57) ABSTRACT

A fuel can (20) is disclosed as having a hollow container body (22), a detachable pouring spout (32), and a fill/vent assembly (36, 132) which is integrally secured to the body (22). In one form, the fill/vent assembly (36) has a primary segment (60) defining a fill opening (66). The segment (66) supports a first, inner, spring-biased pivotal door (42) as well as a second, outer, spring-biased door (50). A flexible check valve (44) is also supported on the inner door (42). In another embodiment, second door is threadably attached to a neck (136) as opposed to being spring-biased into the closed position. In yet another embodiment, the can (20) has only a venting assembly (148) including a flexible check valve (156) supported on a primary segment (154). The segment (154) has venting slots (170) as well as a cap (158) designed to permit venting of the can (20) through the slots (170) and valve (156).

### BACKGROUND OF THE INVENTION

1. Field of the Invention

The present invention is broadly concerned with fuel cans, such as those having having a pour spout for pouring fuel from the internal fuel chamber of the can. More particularly, the present invention concerns a fill assembly of a fuel can, which facilitates filling of the can while preventing inadvertent leakage of fuel. Additionally, the present invention particularly concerns a vent assembly of a fuel can, which facilitates smooth pouring of fuel from the can.

2. Description of the Prior Art

Portable fuel cans for liquid fuels have been provided in a myriad of forms. Generally speaking, these cans have an elongated pour spout allowing the can to be used for filling an automotive fuel tank or the like. The cans have traditionally been fabricated from metal, although in more recent times the cans are almost universally made from synthetic resin materials. Some prior fuel cans of simplified construction are designed for filling through the spout opening, i.e., in order to fill the can it is necessary to detach the elongated pour spout and insert a fuel nozzle into the can. In other cases fuel cans have been provided with separate openings for filling and pouring. See, e.g., U.S. Pat. Nos. 2,764,318, 3,727,807, 3,729,122, 3,794,235, 4,063,667 and 4,645,099. The cans described in these patents do not have self-closing fuel fill assemblies, and none describe an integrally formed fill assembly that is permanently affixed to a fuel can.

Self-closing gas caps have been provided as a part of automotive fuel tanks. Such gas caps are shown in U.S. Pat. Nos. 3,478,922, 4,091,959, 4,265,752, 5,720,328 and 6,035,906. These caps are threaded or otherwise affixed to the filler neck of an automobile gas tank, and have spring-operated doors though which a fuel nozzle is inserted for filling. However, none of these references disclose a portable fuel can with a fill assembly.

Other references of background interest include U.S. Pat. Nos. 2,143,250, 2,547,847, 2,764,318, 3,927,797, 4,889,860 and 4,492,319.

### SUMMARY OF THE INVENTION

The present invention addresses the problems and shortcomings of the prior art. In particular, according to one aspect of the present invention, the inventive fuel can includes a hollow container body defining a fuel chamber adapted to hold a supply of fuel. The can also includes an outlet spout operably coupled with the body and operable to permit pouring of fuel from the chamber and out the spout. Yet further, the can includes a fuel fill assembly integrally fixed to the body in spaced relationship to the spout, with the fill assembly defining an opening sized to receive a fill nozzle. The fill assembly includes a first closure door operable to close the opening when in a closed position. The first closure door is yieldably biased to the closed position and shiftable out of the closed position against the bias as the fill nozzle is inserted into the opening.

Another aspect of the present invention concerns a fuel can including a hollow container body defining a fuel chamber adapted to hold a supply of fuel. The can also includes an outlet spout operably coupled with the body and operable to permit pouring of fuel from the chamber and out the spout. Yet further, the can includes a vent assembly operably coupled with the body in spaced relationship to the spout. The vent assembly presents a vent opening communicating with the fuel chamber. The vent assembly further includes a flexible valve element configured to permit only one-way flow through the vent opening and into the fuel chamber.

In preferred forms, the fill assembly also includes a second closure door for closing the fill opening, with the second door being yieldably biased to its closed position. The first and second closure doors are pivotal about respective, transverse pivot axes. Advantageously, the fill assembly also includes a venting assembly carried by the first door, in the form of a flexible, one-way check valve. The fill assembly also preferably includes a vent assembly according to the second aspect of the present invention.

Other aspects and advantages of the present invention will be apparent from the following detailed description of the preferred embodiment and the accompanying drawing figures.

### BRIEF DESCRIPTION OF THE DRAWING FIGURES

Several embodiments of the invention are described in detail below with reference to the attached drawing figures, wherein:

FIG. 1 is a perspective view of a fuel can constructed in accordance with a preferred embodiment of the present invention, illustrating the improved can fill/vent assembly in the closed position thereof;

FIG. 2 is a fragmentary perspective view similar to FIG. 1, but showing the fill/vent assembly in the open position thereof;

FIG. 3 is an exploded perspective view of the fill/vent assembly depicted in FIGS. 1 and 2;

FIG. 4 is a fragmentary sectional view illustrating the fill/vent assembly in its closed position;

FIG. 5 is a fragmentary sectional view similar to that of FIG. 4, but showing filling of the can with a standard fuel pump nozzle inserted through the open fill/vent assembly;

FIG. 6 is a view similar to that of FIG. 4, but illustrating the venting operation of the fill/vent assembly;

FIG. 6a is a greatly enlarged fragmentary view depicting the preferred construction of the sealing ring forming a part of the fill/vent assembly;

FIG. 7 is a fragmentary top view, with parts broken away, of the fill/vent assembly of FIGS. 1-6, and showing the construction of the vent;

FIG. 8 is a fragmentary, perspective view of another fuel can constructed in accordance with a second preferred embodiment of the present invention, having a modified can fill/vent assembly with a screw cap (serving as the second closure door) in the closed position thereof;

FIG. 9 is a view similar to that of FIG. 8, but showing the screw cap in its opened position;

FIG. 10 is a fragmentary sectional view illustrating the construction of the fill/vent assembly of FIGS. 8 and 9;

FIG. 11 is a perspective view of another fuel can constructed in accordance with a third preferred embodiment of the present invention, having a valve-type vent assembly and no fuel fill assembly;

FIG. 12 is a perspective exploded view showing the components of the vent assembly of FIG. 11;

FIG. 13 is a top view of the vent assembly of FIGS. 11 and 12, with the closure cap being removed for illustrative purposes;

FIG. 14 is a fragmentary sectional view depicting the vent assembly of FIGS. 11-13 in the closed position thereof, and

FIG. 15 is a view similar to that of FIG. 14, but showing the venting operation of the vent assembly.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENT

Turning now the drawings, and particularly FIGS. 1-7, a fuel can 20 selected for illustration includes a hollow container body 22 defining a fuel chamber adapted to hold a supply of fuel. The body 22 has a base 24, a sidewall 26, and a top 28. The top 28 includes an upstanding boss 30 which receives a threadably mounted, elongated outlet or pour spout 32. The top also is equipped with a handle 34 as well as a fill/vent assembly 36. The rear sidewall is also provided with a handle 35. The can 20 is designed to be filled with gasoline or other appropriate liquid fuel through the assembly 36, which (in this embodiment) also serves as a vent to facilitate pouring of fuel through spout 32. Those of ordinary skill in the art will appreciate that the principles of the present invention are equally applicable to alternatively configured fuel cans. For example, the shape of the fuel can and/or spout may be varied without departing from the present invention. In particular, the shape of the can may be more cylindrical, spherical, etc. Furthermore, one or both of the handles can be eliminated entirely, if desirable. The spout may alternatively be configured to self vent, and it is not necessary to arrange either the spout or fill/vent assembly 36 on the top 28.

With the foregoing caveat in mind, the components of the fill/vent assembly 36 will now be described in more detail. Turning specifically to FIG. 3, it will be seen that the assembly 36 includes a primary annular body 38, an O-ring seal 40, closure/vent door 42, flexible valve element 44, biasing spring 46 and spring mount 48. Also, the overall assembly 36 has an outer, second closure door 50 together with biasing spring 52. As will be apparent, the assembly 36 includes a fill assembly operable to permit selective filling of the can and a vent assembly for venting the interior of the container body 22 during pouring of fuel from the spout 32. The combined function of the assembly 36 is most preferred, as it has been determined that placement of the vent assembly with the fill assembly virtually ensures air is permitted to enter the can during pouring of fuel. Furthermore, with this arrangement, access to the interior of the container body 22 is provided at only two locations—the spout 32 and the assembly 36, which enhances safety. However, in regard to some aspects of the present invention, arrangement of the fill and vent assemblies as a single component is unnecessary. For example, as will be apparent from other embodiments disclosed herein, the fill and vent assemblies can be separate or spaced apart or one can be provided on the can without the other.

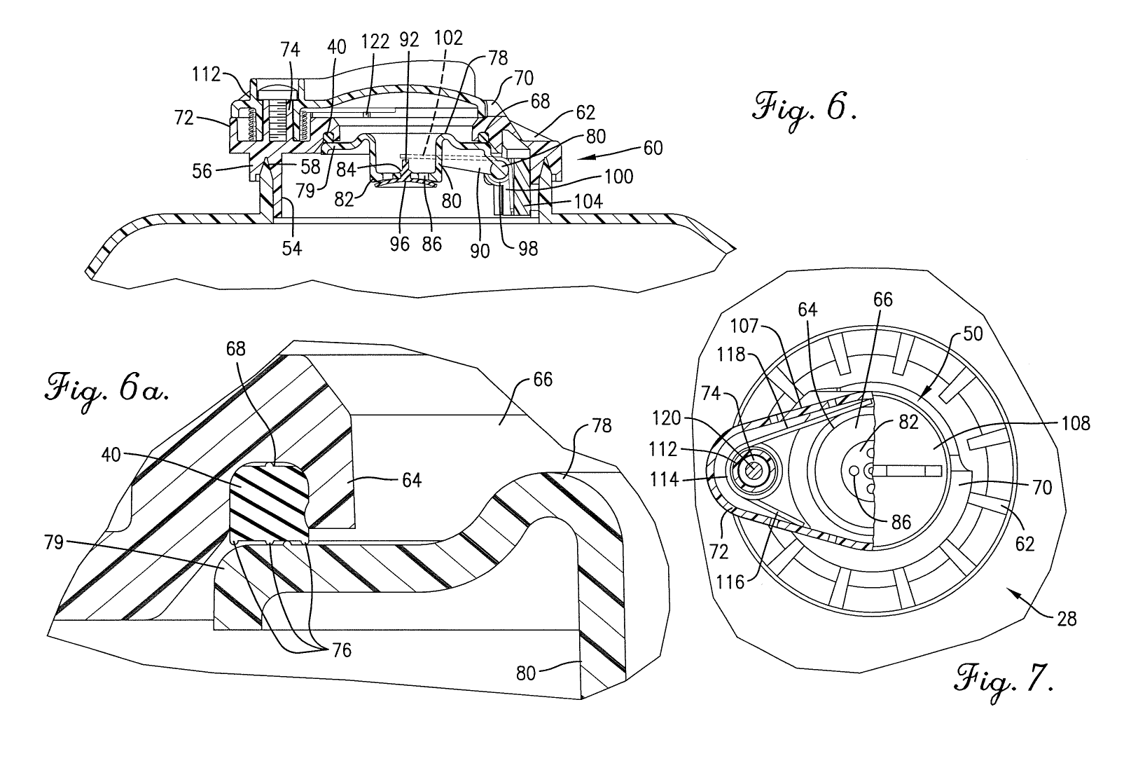

In more detail, the primary body 38 includes a depending, inboard annular wall 54 and a depending, outboard annular wall 56 with an annular slot 58 defined between the walls 54, 56. In addition, the body 38 has a radially enlarged central segment 60 with a series of oblique, upstanding, circumferentially spaced apart strengthening ribs 62. The segment 60 also has a circular inner wall 64 defining a fill opening 66. The wall 64 has a seal-receiving slot 68 formed about the underside thereof. Additionally, an upstanding, arcuate secondary closure door stop 70 is provided adjacent wall 64. As best seen in FIGS. 3 and 6, the segment 60 has an arcuate, upstanding extension wall 72 spaced outwardly from wall 64, with an upstanding, internally threaded boss 74 within the confines of wall 72.

The seal 40 is sized to be permanently received within slot 68 as best seen in FIG. 6, and aids in preventing inadvertent leakage of fuel from the can 20 during use. Referring to FIG. 6a the seal 40 is in the form of an elastomeric ring having three spaced apart, annular, bottommost projecting feet 76 along the underside thereof, the importance of this feature will be made clear hereafter.

The door 42 is annular in configuration, presenting an uppermost, inboard projecting ring 78, an outboard annular sealing ring 79 (with a small annular rib), and a central, depending wall 80 terminating in a lower-most, transversely extending bottom wall 82. The bottom wall 82 has a central through-opening 84 as well as four circumferentially spaced vent openings 86. An elongated, rectilinear pivot 88 is secured to the door 42 by means of arm 90 and serves to permit pivoting movement of the door as will be explained.

The flexible valve component 44 includes an upstanding, central connector 92 having a peripheral skirt 94 as well as a radially enlarged sealing segment 96. The valve 44 is secured to bottom wall 82, i.e., the connector 92 extends through central opening 84 with skirt 94 engaging the upper surface of the bottom wall. The segment 96 is thus disposed in removable covering relationship to the four vent openings 86. In this manner, the wall 82 serves as the valve seat for the valve body 96. The valve component 44 is preferably formed of a suitable elastomeric material.

The spring 46 is designed to bias door 42 to the closed position thereof in engagement with sealing ring 40. To this end spring 46 includes a pair of coil sections 98 separated by a depending bail 100, and with projecting legs 102 extending from each of the coils sections 98. As is readily apparent, the opposed ends of pivot 88 extend through the coil sections 98, whereas the legs 102 engage the underside of door 42. The mount 48 serves to hold spring 46 in place, and includes an outer wall 104 as well as a pair of spaced apart slotted support projections 106. Referring to FIG. 6, it will be appreciated that the outer ends of the coil sections 98 nest within the adjacent projections 106. Although the illustrated spring 46 is preferably metal, the principles of the present invention are equally applicable to alternative spring designs. For example, the spring can alternatively be formed of plastic, comprise a leaf spring or a flexible part of the door 42 itself, etc.

The outer secondary door 50 includes a depending peripheral wall 107 surrounding a substantially circular closure section 108 as well as a projecting attachment section 110. The latter has an upstanding boss 112 designed to fit over and pivot relative to boss 74. The spring 52 has a coil section 114 as well as actuation legs 116, 118. The coil section 104 is disposed about boss 112 with the leg 116 engaging wall 72. The opposite leg 118 engages the depending peripheral wall 107 in order to bias the door 50 to its closed position and in engagement with stop 70. As with the spring 46, it is entirely within the ambit of the present invention to alternatively configure the spring 52. A screw 120 is used to secure the door 50 to boss 74, although other pivot connections may be utilized. Finally, it will be observed that the peripheral wall 107 has a pair of vent notches 122 formed therein, and that a turning grip 124 is provided along the upper surface of the door 50. The doors 42 and 50 are arranged for movement about relatively perpendicular axes, with the pivot axis for the door 50 being at least substantially parallel to the fuel flow axis defined by the assembly 36.

The assembly 36 is preferably secured in an integral fashion to can body 22. Specifically, the body 22 has an opening 126 as well as an adjacent, outwardly projecting, annular integral connection flange 128. The slot 58 between the walls 54 and 56 is designed to receive the flange 128 to thus affix assembly 36 to the can body. Normally, the flange 128 is adhesively secured within the slot 58 by means of adhesive or through conventional welding processes.

### Operation

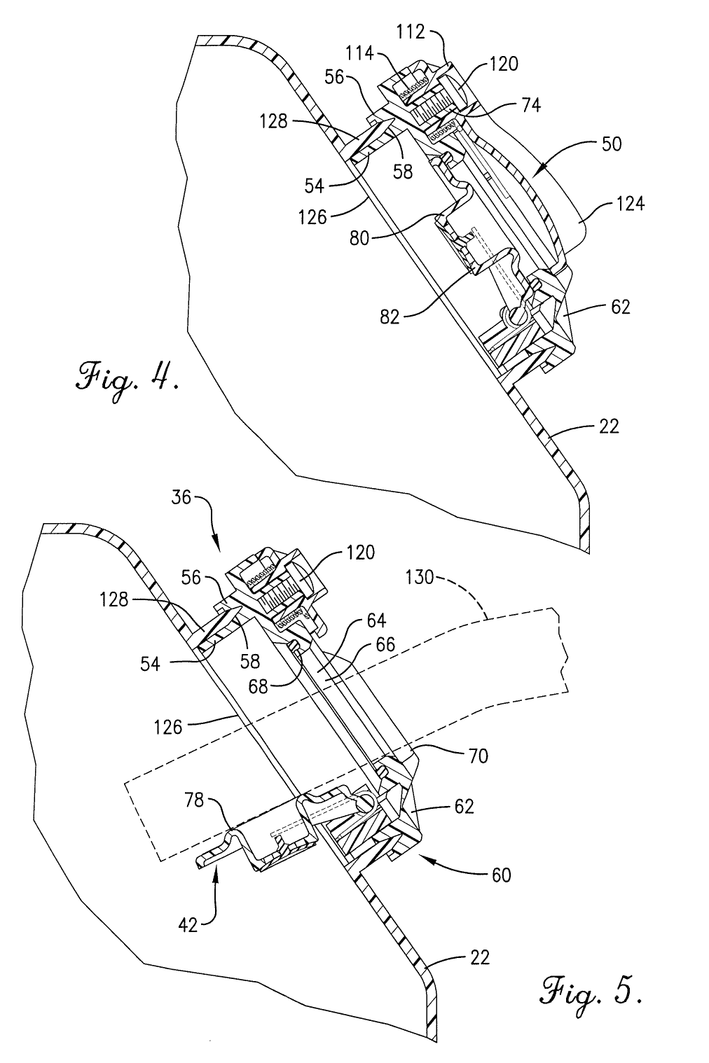

Normally, the first door 42 is biased to its closed position depicted in FIGS. 4 and 6 through the action of spring 46. Similarly, the outer secondary door 50 is biased to its closed position under the influence of spring 52. Thus, the overall assembly 36 provides a pair of separate closure doors, pivotal about respective, transverse axes, in order to provide an enhanced anti-leak function. This is augmented by the specialized construction of seal 40, with the feet 76 in engagement with ring 79 (FIG. 6a). Particularly, the two radially innermost feet 76 are in an opposed, radially-spaced relationship with the rib of ring 79 to enhance the sealing engagement provided therebetween.

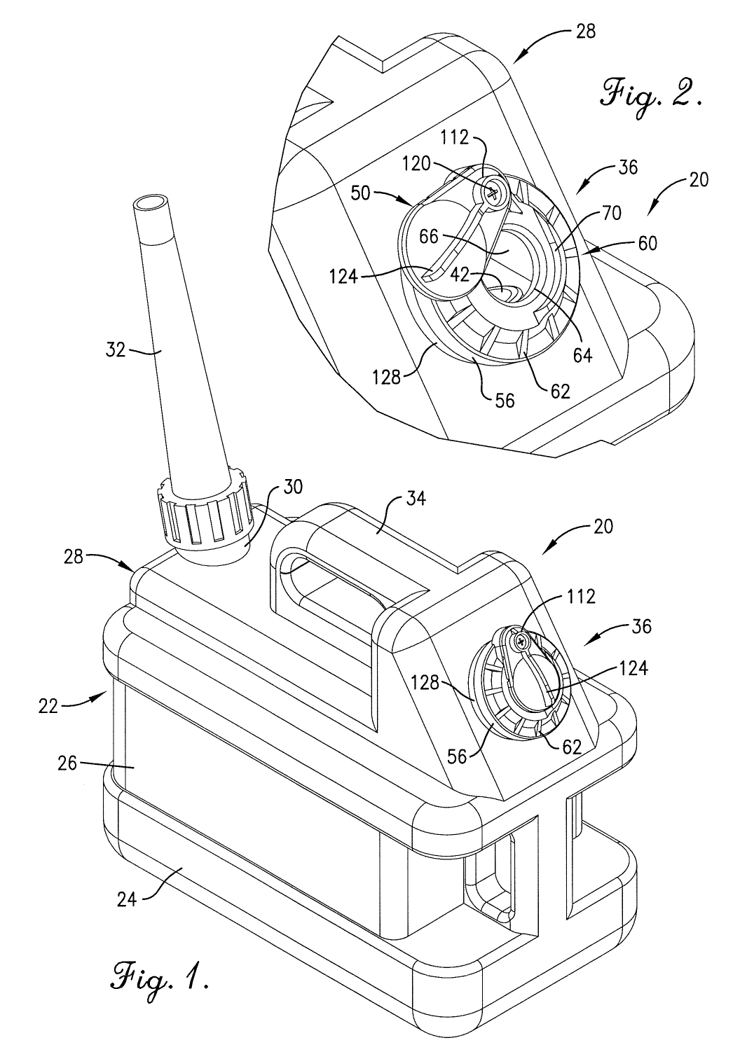

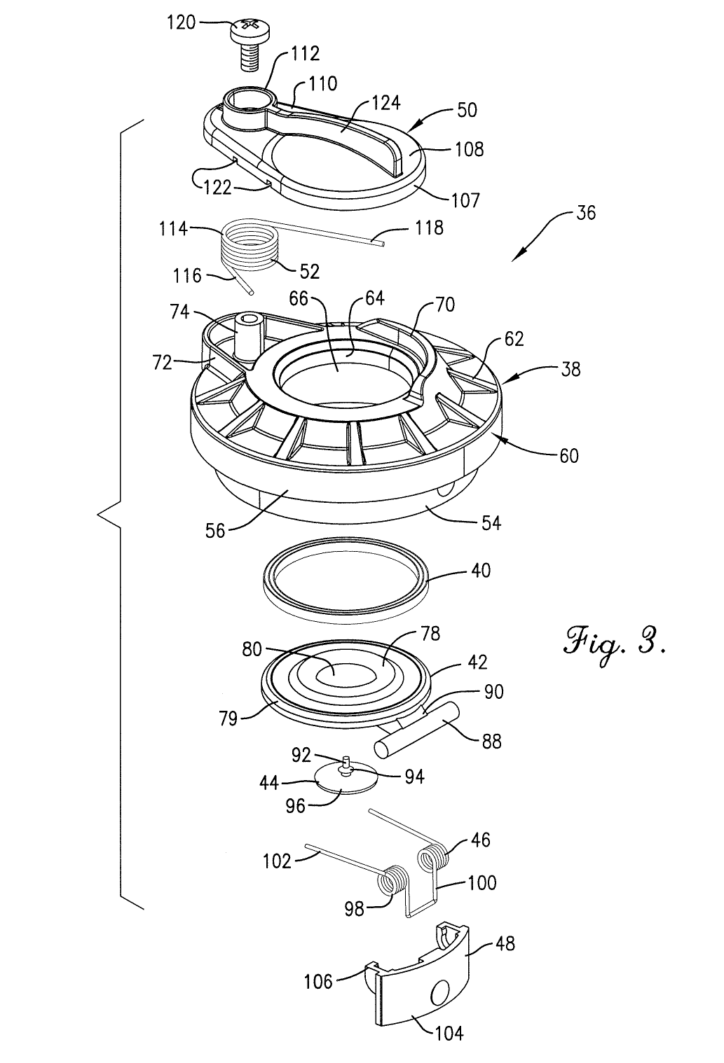

The assembly 36 allows ready filling of the can 20 with fuel. This operation is illustrated in FIG. 5, where a conventional fuel delivery nozzle 130 is inserted through assembly 36 in order to fill the can body 22. Specifically, filling is accomplished by first manually pivoting door 50 to its opened position illustrated in FIGS. 2 and 5, against the bias of spring 52. This is facilitated by the grip 124. Thereupon, the nozzle 130 is inserted into and through the opening 66, such action serving to open the inner door 42 against the bias of spring 46. In this regard, it will be seen that the provision of inner projecting ring 78 on door 42 permits easy opening of the door and insertion of nozzle 130. Furthermore, the ring 78 reduces the risk of contact between the nozzle 130 and the from contacting the valve component 44 and the sealing ring 79. When the can body 22 is filled with fuel, the nozzle 130 is withdrawn, thereby permitting the door 42 to be returned to its original closed position under the spring bias. The secondary door 50 is then released by the user (or has already been released by the user during filling) so that the spring bias returns the door 50 to its closed position against stop 70.

The assembly 36 also serves as air makeup vent during dispensing of fuel through spout 32. Specifically, as fuel is poured from spout 46, the pressure within the body 22 typically drops, and the vent assembly 36 consequently permits air to pass through the vent notches 122 and thence through vent openings 86 into the can body 22. The valve segment 96 yields and flexes as necessary, permitting passing of such air. It is particularly appreciated that the valve assembly is configured to permit only one-way flow of fluid into the interior of the body 22. That is to say, the valve assembly functions as a check valve, restricting fluid flow out of the body but being readily opened when the pressure within the body 22 drops sufficiently below atmospheric to cause the segment 96 to flex and thereby uncover the vent openings 86. It is has been determined that the illustrated valve design is particularly unique and desirable as a result of its simple yet highly effective design. In particularly, the flexible segment 96 naturally rests against the wall 82 (and is urged into contact therewith because of its resiliency and preferably flexed condition when connected) to prevent fuel flow out of the body 22, but the segment 96 readily flexes when negative pressure is generated within the body 22 as typically occurs during pouring of fuel from the spout 32.

### ALTERNATIVE EMBODIMENTS

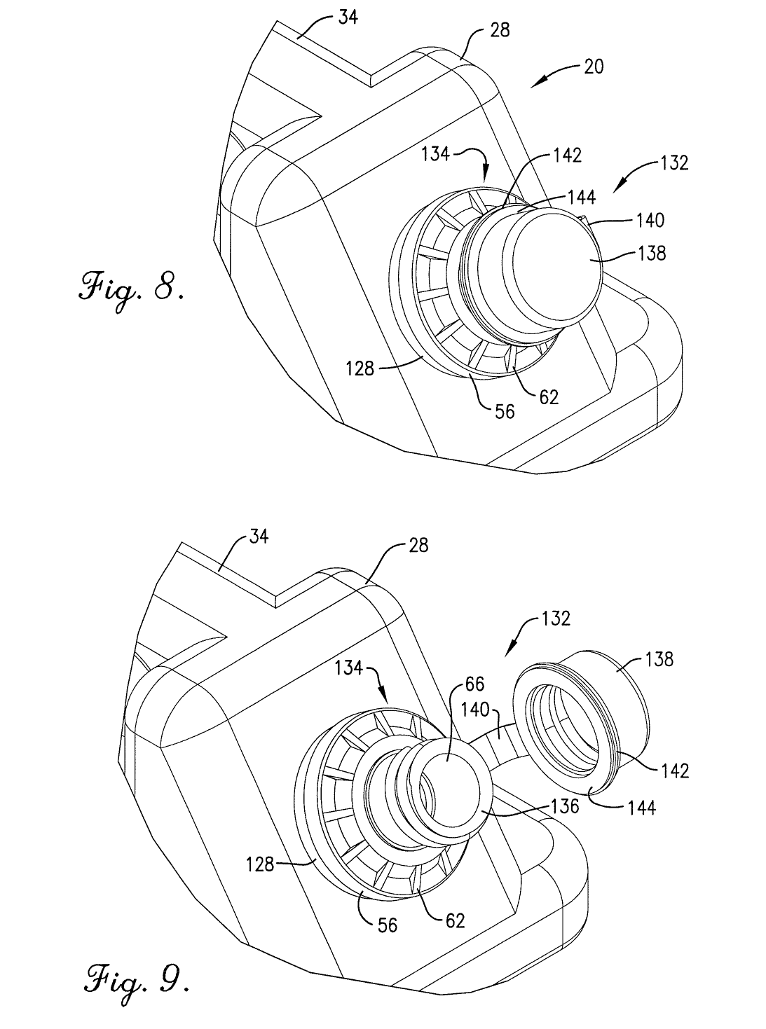

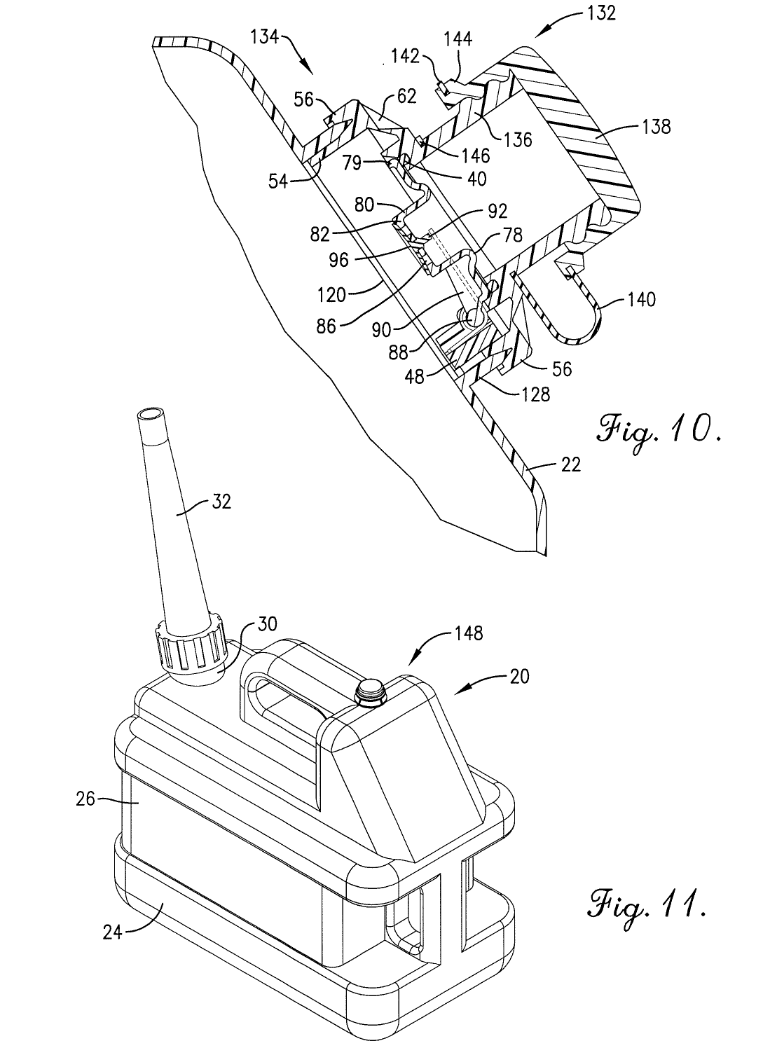

FIGS. 8-10 illustrate a fuel can 20 as described above, provided with a fill/vent assembly 132. For the most part, the assembly 132 is identical with assembly 36, and therefore identical components of the assemblies are identically numbered, and only the differences between the assemblies will be specifically described. Thus, the assembly 132 includes a primary segment 134 which differs from segment 60 only in that the segment 134 includes an integral, outwardly extending, externally threaded tubular extension 136. Furthermore, the assembly 132 does not have the spring-biased pivotal secondary door 50 and associated hardware, but rather the extension 136 is closed by means of a threaded secondary door 138. Preferably, the door 138 is secured to segment 134 via a flexible tether 140. The tether 140 is secured by means of connection ring 142 which circumscribes the enlarged lower bead 144 of door 138, as well as lower connection ring 146 circumscribing the extension 134.

The use of assembly 132 for filing of can 20 involves unthreading of door 138 from extension 136, thereby exposing the fill opening 66 and permitting insertion of nozzle 130. When the filling operation is completed, the procedure is reversed. In other words, the door 138 is threaded onto extension 136. The assembly 132 provides a venting function by removal of the door 138 as fuel is poured from spout 32.

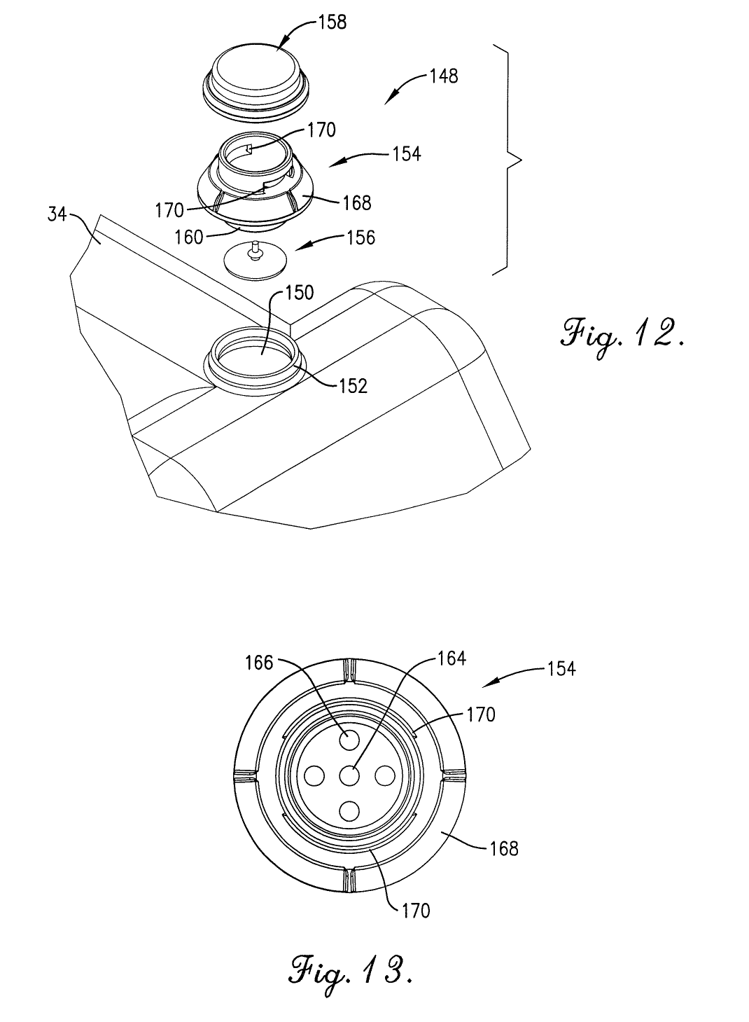

FIGS. 11-15 illustrate a fuel can 20 that does not include a combined fuel/vent assembly as shown in the embodiments of FIGS. 1-10. Instead, the can 20 includes only a venting assembly 148 spaced from the traditional spout 32. In this instance, the can 20 is filled in the customary manner by unscrewing the spout 32 from boss 30 and inserting nozzle 130 into the can through the boss. When filling is completed, the spout 32 is reattached. The can 20 in this instance has a vent assembly opening 150 defined by an upstanding flange 152, adapted to receive and support the assembly 148. The latter is made up of three components, namely a primary segment 154, a flexible valve 156, and a cap 158.

The segment 154 has a tubular sidewall 160 with a transverse bottom wall 162 equipped with a central opening 164 as well as four circumferentially spaced vent openings 166. The sidewall 160 also has a circumscribing, downturned lip 168 designed to receive flange 152, as well as a pair of opposed venting slots 170 above the lip 168.

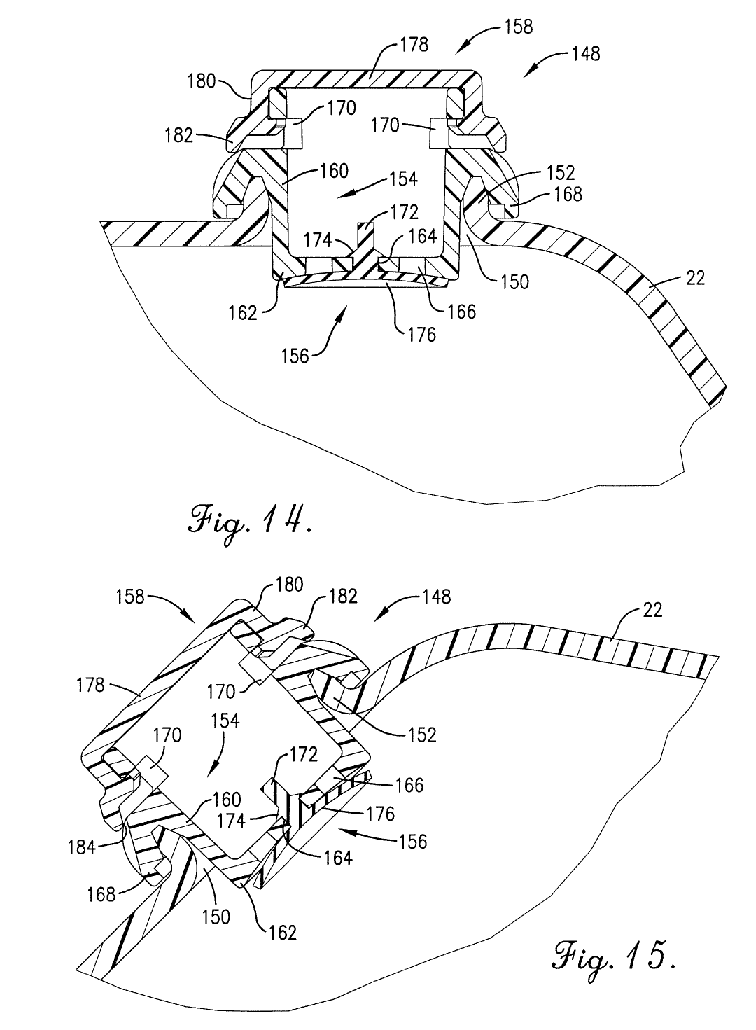

The valve 156 is essentially identical with previously described valve 44, in that it includes a central, upstanding connector 172 having a skirt 174, as well as a lowermost, radially enlarged section 176. As illustrated in FIGS. 14 and 15, the connection 172 extends through central opening 164, with skirt 174 engaging the upper surface of bottom wall 162. In this orientation, the section 176 is in covering relationship to vent openings 166. The segment 154 with attached valve 156 is permanently secured to can 20 as illustrated in FIGS. 14 and 15. In particular, the flange 152 fits within the slot-like recess defined by lip 168, and the segment 154 is adhesively secured in place.

The cap 158 includes a top wall 178, as well as a depending sidewall 180 terminating in a radially enlarged lip 182. The lip 182 is designed to come in to close adjacency with the upper surface of lip 168, while leaving a small circular vent space 184 in communication with the slots 170. The space 184 and slots 170 cooperatively define a vent passageway that is fluidly interposed between the vent openings 166 and atmosphere. It is also noted that the passageway is oriented in a generally transverse relationship to the vent openings 166, which is believed to reduce the risk of leakage in the event of valve failure or mishandling.

In operation, when the can 20 is used to deliver fuel through spout 32 and sufficient negative pressure is generated within the can 20 to cause the section 176 to flex and uncover the vent openings 166, makeup air passes through vent passageway 184, slots 170 and through the openings 166 into can 20. During this operation, the section 176 is slightly deflected away from the openings 166, as best seen in FIG. 15. At the same time, the provision of cap 158 substantially prevents any leakage of fuel from the can 20 and essentially ensures the valve is tamper-proof.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A fuel can operable to store a supply of fuel received from a fill nozzle, said fuel can comprising:
a hollow container body defining a fuel chamber adapted to hold the supply of fuel;
an outlet spout operably coupled with said body and operable to permit pouring of fuel from the chamber and out the spout; and
a fuel fill assembly integrally fixed to said body in spaced relationship to said spout, with the fill assembly defining an opening sized to receive the fill nozzle,
said fill assembly including a first closure door operable to close the opening when in a closed position,
said first closure door being yieldably biased to the closed position and shiftable out of the closed position against the bias as the fill nozzle is inserted into the opening.

2. The fuel can as claimed in claim 1,
said fill assembly including a second closure door operable to close the opening when in a shut position thereof.

3. The fuel can as claimed in claim 2,
said fill assembly including a first spring operably coupled with the first door to bias the first door to the closed position thereof.
said fill assembly including a second spring operably coupled with the second door to bias the second door to the shut position thereof.

4. The fuel can as claimed in claim 2,
said first and second doors being spaced apart and pivotal about respective, transverse pivot axes.

5. The fuel can as claimed in claim 4,
said fill assembly presenting a fluid fill axis, with the pivot axis of the first door being substantially perpendicular to the fill axis and the pivot axis of the second door being substantially parallel to the fill axis.

6. The fuel can as claimed in claim 2,
said fill assembly including a threaded extension,
said second closure door operable for closing said opening, said second door being threadably secured to extension.

7. The fuel can as claimed in claim 6,
said fill assembly including a tether connected between the second door and the threaded extension.

8. The fuel can as claimed in claim 2; and
a venting assembly configured to permit only one-way flow into the fuel chamber.

9. The fuel can as claimed in claim 8,
said venting assembly being carried by the first door,
said second door being fluidly outside of the first door relative to the fuel chamber,
said second door presenting at least one vent opening so that vented flow into the fuel chamber passes freely therethrough.

10. The fuel can as claimed in claim 1; and
a venting assembly configured to permit only one-way flow into the fuel chamber.

11. The fuel can as claimed in claim 10,
said venting assembly comprising an apertured plate,
said venting assembly including a flexible, one-way valve element sealingly engaging said plate.

12. The fuel can as claimed in claim 11,
said venting assembly being carried by the first closure door.

13. A fuel can operable to store a supply of fuel received from a fill nozzle, said fuel can comprising:
a hollow container body defining a fuel chamber adapted to hold the supply of fuel;
an outlet spout operably coupled with said body and operable to permit pouring of fuel from the chamber and out the spout; and
a vent assembly operably coupled with said body in spaced relationship to said spout,
said vent assembly presenting a vent opening communicating with the fuel chamber,
said vent assembly further including a flexible valve element configured to permit only one-way flow through the vent opening and into the fuel chamber.

14. The fuel can as claimed in claim 13; and
a fuel fill assembly integrally fixed to said body in spaced relationship to said spout, with the fill assembly defining an opening sized to receive the fill nozzle,
said fill assembly including a first closure door operable to close the opening when in a closed position,
said first closure door being yieldably biased to the closed position and shiftable out of the closed position against the bias as the fill nozzle is inserted into the opening.

15. The fuel can as claimed in claim 14,
said venting assembly being carried by the first door.

16. The fuel can as claimed in claim 13,
said vent assembly including apertured wall defining the vent opening,
said valve element operably engaging said apertured wall.

17. The fuel can as claimed in claim 16,
said apertured wall including an apertured portion in which the vent opening is defined,
said valve element including a central projection in interlocking relationship with said apertured wall,
said valve element including an outwardly extending closure segment in covering relationship to the apertured portion of the wall.

18. The fuel can as claimed in claim 16,
said vent assembly including a tubular component fixed to the container body,
said apertured wall forming part of the tubular component.

19. The fuel can as claimed in claim 18,
said vent assembly including a cap secured to the tubular component.

20. The fuel can as claimed in claim 19,
said tubular component and cap cooperatively defining a vent passageway fluidly interposed between the vent opening and the atmosphere.

21. The fuel can as claimed in claim 20,
said vent opening defining a first vent axis,
said vent passageway defining a second vent axis that is generally transverse to the first vent axis.
